(19) United States
(12) Patent Application Publication
(10) Pub. No.: US 2017/0283743 A1
(43) Pub. Date: Oct. 5, 2017

(54) MULTI-LAYER SELF-ADHESIVE GEL AND APPLICATOR

(71) Applicant: Henkel AG & Co. KGaA, Duesseldorf (DE)

(72) Inventors: Uwe Trebbe, Duesseldorf (DE); Michael Horn, Duesseldorf (DE); Robert Stephen Cappleman, Duisburg (DE); Bernhard Orlich, Duesseldorf (DE); Marine Cabirol, Duesseldorf (DE); Lars Zuechner, Langenfeld (DE)

(73) Assignee: Henkel AG & Co. KGaA, Duesseldorf (DE)

(21) Appl. No.: 15/629,958

(22) Filed: Jun. 22, 2017

Related U.S. Application Data
(63) Continuation of application No. PCT/EP2015/080422, filed on Dec. 15, 2015.

(30) Foreign Application Priority Data
Dec. 23, 2014 (EP) 14199972.2

(51) Int. Cl. C11D 3/20; C11D 1/29; B05C 17/005; C11D 3/43; C11D 17/00; E03D 9/02; C11D 1/14; C11D 3/50

(52) U.S. Cl. CPC C11D 3/2068; C11D 1/143; C11D 1/29; C11D 3/50; C11D 3/43; C11D 17/003; E03D 9/02; B05C 17/00553; B05C 17/00579; E03D 2009/026

(57) ABSTRACT

Provided is a multi-layer self-adhesive gel suitable for use in cleaning, disinfecting, deodorizing, and/or scenting of toilets, sinks, wash-bowls, bathtubs, showers, and for delivery of shower gel or shampoo in the shower, bathtub or wash-bowl. The multi-layer self-adhesive gel has at least two different self-adhesive gel layers. One gel layer (A) includes at least one solvent (a1), at least one adhesion promoter (b1) which is different from (a1), and at least one surfactant (c1) which is different from (a1) and (b1). Another gel layer (B) includes at least one solvent (a2), at least one adhesion promoter (b2) which is different from (a2). When the multi-layer self-adhesive gel is applied onto a flat surface of a substrate, (A) and (B) together have a continuous, essentially even surface, remote from the surface of the substrate. Also provided are an applicator containing the multi-layer self-adhesive gel and methods of filling the applicator.

### FIELD OF THE INVENTION

The present invention relates to household products for cleaning, disinfecting, deodorizing, and/or scenting.

### BACKGROUND OF THE INVENTION

For a long time, sanitary agents are employed in cleaning, disinfecting and scenting of toilets. Generally, there are three types of toilet cleaning agents, solid blocks which need a hanger (also referred to in the art as rimblocks) when employed in the toilet. The second type are liquid cleaners which need a delivery system which is placed into the toilet; and the third type which are based on gel materials and which are often self-adhesive so that they can be directly placed on the wall of the toilet. In the last years, the gel based cleaning agents get more and more popular and economically important, since the consumers do not need to touch the empty hanger in the toilet to remove it after the sanitary agent is completely dissolved. Such self-adhesive gels and applicators therefore are generally known in the art.

For example, EP 1325103A and EP 1086199A disclose specific sanitary agents which adhere directly to the sanitary object. However, these applications disclose solely a single homogenous composition. WO2007008531A discloses a specific device for applying controlled doses of a flowable adhesive material to a surface, however, only one kind of a homogenous gel is employed in the device.

There is a need for multi-layer self-adhesive gels, which can for example be employed in the toilet, if the use of different gels can ensure characteristics of the whole product, which are not possible to obtain by a single gel. For example, to have one gel which is used for cleaning and/or disinfecting the toilet whereas the other gel can permanently scent the air. Another advantage is that two desired compounds which cannot be delivered via one gel, e.g. since they do not form a gel if they are contained in one composition or alter the gel in an undesired way, can be provided.

WO2013020597A discloses an applicator which is able to provide simultaneously two gels into the toilet bowl. However, as can be seen from FIG. 6 of this application, the obtained product has a rather unappealing appearance. Furthermore, due to two separate chambers it is difficult for the user of such an applicator to easily apply two gels simultaneously having the same weight. This results either in an undesired inhomogeneous impression of the final product and to the undesirable result that one of the chambers is earlier finished or that he has to push one of the chambers again so that it will result in different shapes of the two gels of the final product in the toilet bowl. A further disadvantage of such a cleaning composition is that the different surface areas due to the different shapes will lead to different dissolution rates. Moreover, due to the two chambers the interface of the two applied gels in almost every case will not be continuous. Thus, after several flushes two single gel spots will remain in the toilet, which is visually unappealing. Furthermore, two pistons and chambers are necessary and thus the user needs more force which makes the application not comfortable. Additionally, such an applicator generates more waste as more raw materials are necessary for a two-chamber applicator having two pistons etc.

Accordingly, it is desirable to provide a gel composition comprised of homogeneous or heterogeneous gel layers in order to impart same or different functions. It is also desirable that such gel composition has an appealing appearance before, during, and after use. It is further desirable to provide an applicator which allows an easy filling of the multi-layer gel composition into a single chamber of the applicator. Furthermore, other desirable features and characteristics of the present invention will become apparent from the subsequent detailed description of the invention and the appended claims, taken in conjunction with this background of the invention.

It has been surprisingly found that with the multi-layer self-adhesive gel and applicator according to the present invention these disadvantages can be overcome.

### BRIEF SUMMARY OF THE INVENTION

In one aspect, the present invention relates to a multi-layer self-adhesive gel, for cleaning and/or disinfecting and/or deodorizing and/or scenting which comprises:
i) a first self-adhesive gel layer (A) comprising
   at least one solvent (a1);
   at least one adhesion promoter (b1), which is different from (a1); and
   at least one surfactant (c1), which is different from (a1) and (b1)
ii) a second self-adhesive gel layer (B), which is different from the first self-adhesive gel layer (A), comprising
   at least one solvent (a2); and
   at least one adhesion promoter (b2), which is different from (a2); and preferably
   at least one surfactant (c2), which is different from (a2) and (b2), wherein
      when the multi-layer self-adhesive gel is applied onto a flat surface of a substrate, (A) and (B) together have a continuous, essentially even surface, remote from the surface of the substrate.

In another aspect, the present invention relates to the use of the multi-layer self-adhesive gel according to the present invention for cleaning and/or disinfecting and/or deodorize and/or scenting of toilets, sinks, wash-bowls, bathtubs, showers and for delivery of shower gel or shampoo in the shower, bathtub or wash-bowl.

Furthermore, the present invention relates to an applicator, preferably for toilet cleaning products, comprising one receiving chamber containing the multi-layer self-adhesive gel according to the present invention and having a first opening, wherein the first opening is provided in order to release the gel, and a second opening, wherein the second opening is provided in order to accommodate a piston, which can be moved in the receiving chamber and by means of which the gel can be pushed through the first opening, and wherein the multi-layer self-adhesive gel is arranged in the receiving chamber so that parts of all self-adhesive layers, preferably equal amounts of each of the adhesive layers, contained in the receiving chamber are able to simultaneously leave the receiving chamber through the first opening.

Preferably, the applicator according to the present invention is employed to obtain the multi-layer self-adhesive gel according to the present invention.

Moreover, the present invention relates to methods for filling the applicator according to the present invention:

a method for filling of the applicator according to the present invention, wherein a first gel is molten and filled in a first filling step into the receiving chamber through the first opening, subsequently the gel is allowed to cool or actively cooled, with the applicator being in a horizontal position, until it becomes solid and forms the first self-adhesive gel layer (A); then a second gel is molten and filled in a second filling step into the receiving chamber via the first opening, subsequently the gel is allowed to cool or actively cooled until it becomes solid, forming the second self-adhesive gel layer (B);
optionally then a third gel is molten and filled in a third filling step into the receiving chamber via the first opening, with the proviso that the applicator in the cooling step of the second filling step is in a horizontal position with the proviso that the piston is present in the receiving chamber from the beginning of the filling steps.

A method for filling of the applicator according to the present invention, wherein a molten first gel, forming the first self-adhesive gel layer (A), and a molten second gel, forming the second self-adhesive gel layer (B) and optionally a molten third gel, forming the third self-adhesive gel layer (C), are simultaneously filled into the receiving chamber via nozzles of a gel providing apparatus through the second opening; wherein at least one separative element is present between the nozzles for avoiding mixing of the gels being filled into the receiving chamber, and wherein the at least one separative element is pulled out of the receiving chamber, together with the nozzles, through the second opening until the receiving chamber is filled up to the means for pressure compensation.

A method for filling the applicator according to the present invention, comprising the steps:

providing the receiving chamber in a horizontal position;
pumping a first gel, forming the first self-adhesive gel layer (A) into the receiving chamber with a temperature of the gel below at least 60° C. of its gel point; and
simultaneously filling a molten second gel, forming the second self-adhesive gel layer (B), into the receiving chamber, wherein the second gel congeals at the interface with the first gel.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The term “gel” according to the invention has the meaning as commonly known to the skilled person. Preferably according to the present invention “gel” refers to compositions which have a yield point which is under application conditions at 25° C. through gravitation not overcome and which storage module by a shear deformation of 1%, measured via a rotational rheometer (oscillating measurement, 1 Hz, plate-plate, cross-hatched) at 25° C. has a higher value then the corresponding loss modulus. The term “self-adhesive” relates to compositions which directly adhere to the sanitary object upon which they are applied without the need of a hanger.

In the following compounds of the composition may be named according to the International Nomenclature Cosmetic Ingredient (INCI) nomenclature (International Cosmetic Ingredient Dictionary and Handbook—Seventh Edition (1997) published by The Cosmetic, Toiletry, and Fragrance Association (CTFA), 1 101 17th Street, NW, Suite 300, Washington, D.C. 20036, USA.

The term “CAS” means that the subsequent sequence of numbers is a denotation of the Chemical Abstracts Service.

In the present specification, the terms “a” and “an” and “at least one” are the same as the term “one or more” and can be employed interchangeably.

According to the invention fatty acids and fatty alcohols respectively or their derivatives are unless otherwise stated considered as branched or unbranched carbon acids or alcohols respectively or their derivative preferably having 6 to 22 carbon atoms, more preferably 8 to 20 carbon atoms, even more preferred 10 to 18 carbon atoms, and most preferred 12 to 16 carbon atoms. Fatty acids are in particular preferred from an ecological point of view since they are plant-derived and thus derived from a renewable resource. Additionally, oxo-alcohols or their derivatives, obtainable according to Roelen's oxo-synthesis, are preferred which preferably have 7 to 19 carbon atoms, more preferably 9 to 19 carbon atoms, even more preferred 9 to 17 carbon atoms, most preferred 11 to 15 carbon atoms.

The present invention relates to multi-layer gels which means that the two or more gels have to have at least one difference in their composition or characteristic, e.g., different solvents, adhesion promoters, surfactants, perfumes, additives or the presence of surfactants, perfume, additives in only one gel, or different colors, smells, viscosities, amounts of one or more of the components, solubility rates, dissolving rates, opacities, transmittances, scenting strengths, antimicrobial strengths, or cleaning strengths. The aforementioned examples are only exemplary and not intended to limit the scope of the present invention.

In the following the multi-layer gel comprising gels (A), (B) and optionally (C), also referred to as “gels” in the following, is described in more detail.

Solvents

Solvents (a1), (a2) and (a3) according to the present invention, in the following also referred to as “solvents” are compounds which are liquid at 25° C. Preferably (a1) and/or (a2) and/or (a3) are independently selected from water; glycol or derivatives thereof, like 1,2-ethylene glycol, 1,2-propylene glycol, 1,2-butylene glycol, propylene glycol-n-butyl ether, dipropylen glycol methyl ether, diethylene glycol, triethylen glycol, polymethylene glycol, polyethylene glycol; glycerin and its derivatives, like glycerin triacetate, dihydroxy compounds, like 1,3-dihydroxy propane, 1,3-dihydroxy butane, 1,4-dihydroxy butane, dihydroxy isobutane, dihydroxyl pentane, trihydroxy hexane, trihydroxy heptane; alpha-hydroxy acids like lactic acid; alcohols, like alcohols having 1 to 10 carbon atoms in the main chain; diols having 1 to 10 carbon atoms in the main chain; triols, having 1 to 10 carbon atoms in the main chain; and polyols like oligosaccharides, monosaccharides, disaccharides, sorbitol, pentaerithrytol or mixtures thereof. They can be the same or different.

In preferred embodiments, the solvents in the respective gels are respectively water, in more preferred embodiments the solvents are respectively a mixture of water and an additional solvent independently selected from the above-mentioned solvents.

In preferred embodiments, the solvents are respectively present in 5 to 70 wt.-%, more preferably 20 to 60 wt.-%, most preferably 30 to 55 wt.-%, based on the total weight of the respective gel. In further preferred embodiments, the water is respectively present in the gels in an amount of 5 to 60 wt.-%, more preferably 10 to 50 wt.-%, most preferably 15 to 40 wt.-%.

Adhesion Promoters

Adhesion promoters (b1), (b2) and (b3), in the following also referred to as “adhesion promoters” suitable in the present invention are known to the skilled person. In preferred embodiments the at least one adhesion promoter (b1) and/or (b2) and/or (b3) is independently selected from fatty alcohol ethoxylates, preferably fatty alcohol ethoxylates like defined above, cellulose, polysaccharides or derivatives thereof, oligosaccharides or derivatives thereof, monosaccharides or derivatives thereof, alginates, diurethanes, pectines, oleyl amines, alkyl dimethyl amine oxides, stearates, sodium dodecylbenzene sulfonates, gelatines, starches, modified starches, agar, acacia gum, carob bean flour, oligomers and polymers, polyvinyl alcohols and polyvinyl pyrrolidones or combinations thereof.

Suitable Mono-, oligo-, and polysaccharides and derivatives thereof are for example disclosed in WO 2014180579 A.

Suitable oligomers or polymers can be based on polyisobutenyl succinic acid which are disclosed in EP WO 2014033259 A are suitable as well. Furthermore, in preferred embodiments the respective gel can have a specific composition as disclosed in WO 2014033259 A.

Suitable oligo- or polymers also comprise polyacrylates, acrylic copolymers and block copolymers derived from oligo- or polyethylene oxide and/or oligo- and/or polypropylene oxid and/or oligo- and/or polybutylene oxide as disclosed in EP 1318191 A1.

In preferred embodiments the adhesion promoters are independently selected from fatty alcohol ethoxylates, oligo- or polymers based on polyisobutenyl succinic acid, polysaccharides or derivatives thereof, oligosaccharides or derivatives thereof, monosaccharides or derivative thereof and sodium dodecyl benzene sulfonate.

In preferred embodiments, the adhesion promoters are respectively present in 1 to 60 wt.-%, more preferably 5 to 50 wt.-%, most preferably 20 to 40 wt.-%, based on the total weight of the respective gel.

Surfactants

Surfactants (c1), (c2) and (c3), in the following also referred to as “surfactants”, can be respectively selected from non-ionic, anionic, amphoteric or cationic surfactants or combinations thereof.

Suitable non-ionic surfactants for use in the present invention preferably include alkoxylates such as polyglycol ethers, fatty alcohol polyglycol ethers, alkylphenol polyglycol ethers, end-capped polyglycol ethers, mixed ethers and hydroxy mixed ethers, and fatty acid polyglycol esters. Ethylene oxide/propylene oxide block polymers, fatty acid alkanolamides and fatty acid polyglycol ethers may also be used. Another important class of nonionic surfactants that may be used are the polyol surfactants and in particular the glycol surfactants, such as alkyl polyglycosides and fatty acid glucamides. The alkyl polyglycosides are particularly preferred, in particular the alkyl polyglucosides as well as above all the fatty alcohol alkoxylates (fatty alcohol polyglycol ethers).

Preferred fatty alcohol alkoxylates employed as nonionic surfactants are unbranched or branched, saturated or unsaturated C8-C22 alcohols alkoxylated with ethylene oxide (EO) and/or propylene oxide (PO) with a degree of alkoxylation of up to 30, preferably ethoxylated C12-22 fatty alcohols with a degree of ethoxylation of less than 30, preferably 12 to 28, particularly 20 to 28, particularly preferably 25, for example C16-18 fatty alcohol ethoxylates containing 25 EO.

Alkyl polyglycosides are surfactants that can be obtained by the reaction of sugars and alcohols using appropriate methods of preparative organic chemistry, whereby according to the method of preparation, one obtains a mixture of monoalkylated, oligomeric or polymeric sugars. Preferred alkyl polyglycosides are the alkyl polyglucosides, wherein the alcohol is particularly preferably a long-chain fatty alcohol or a mixture of long-chain fatty alcohols with branched or unbranched C8 to C18 alkyl chains and the degree of oligomerization (DP) of the sugar is between 1 and 10, advantageously 1 to 6, particularly 1.1 to 3, most preferably 1.1 to 1.7, for example C8-10 alkyl-1.5-glucoside (DP of 1.5).

Nonionic surfactants of the amine oxide type, for example N-cocoalkyl-N,N-dimethylamine oxide and N-tallow-alkyl-N,N-dihydroxyethylamine oxide, and of the fatty acid alkanolamide type, may also be suitable. The amount of these nonionic surfactants is preferably not more than that of the ethoxylated fatty alcohols as defined in the following, in particular not more than half thereof.

Fatty alcohol ethoxylates are preferably employed in amounts of up to 30 wt %, particularly preferably 4 to 20 wt %, and particularly preferably from 7 to 15 wt % based on the total weight of the respective gel. Additional nonionic surfactants, such as fatty acid monoalkanolamides and/or alkyl polyglycosides, may be included in amounts of up to 10 wt %.

Suitable anionic surfactants which can be employed are aliphatic sulfates such as fatty alcohol sulfates, fatty alcohol sulfonates, fatty alcohol ether sulfates, dialkyl ether sulfates, monoglyceride sulfates, and aliphatic sulfonates such as alkane sulfonates, ether sulfonates, n-alkyl ether sulfonates, ester sulfonates, alkyl benzene sulfonates and lignin sulfonates. Fatty acid cyanamides, sulfosuccinates, particularly the C8 to C18 alkyl mono and diesters of succinic acid, sulfosuccinamates, sulfosuccinamides, sulfoestolides, fatty acid isethionates, acylaminoalkane sulfonates (fatty acid taurides), fatty acid sarcosinates, ether carboxylic acids and alkyl (ether) phosphates as well as alpha-sulfofatty acid salts, acylglutamates, monoglyceride disulfates and alkyl ethers of glycerin disulfate can likewise be used in the context of the present invention.

The fatty alcohol sulfates and/or fatty alcohol ether sulfates, in particular the fatty alcohol sulfates, can be employed in preferred embodiments of the present invention. Fatty alcohol sulfates are products from sulfating reactions on corresponding alcohols, whereas fatty alcohol ether sulfates are products of sulfating reactions on alkoxylated alcohols. In the context of the present invention, alkoxylated alcohols are generally understood by the person skilled in the art to mean the reaction products of alkylene oxide, preferably ethylene oxide, with alcohols, preferably with the longer chain alcohols. As a rule, n moles of ethylene oxide react with one mole of alcohol to form, depending on the reaction conditions, a complex mixture of addition products with different degrees of ethoxylation. Another embodiment of the alkoxylation consists in the use of mixtures of the alkylene oxides, preferably a mixture of ethylene oxide and propylene oxide. Preferred fatty alcohol ether sulfates are the sulfates of low-ethoxylated fatty alcohols with 1 to 4 ethylene oxide units (EO), in particular 1 to 2 EO, for example 1.3 EO.

The anionic surfactants are preferably added as their sodium salts, but can also be comprised of other alkali metal or alkaline earth metal salts. These include for example magnesium salts, as well as ammonium or mono-, di-, tri- or tetraalkylammonium salts. In the case of the sulfonates, the acid form may be used, e.g. dodecylbenzene sulfonic acid.

Besides the previously cited surfactant types, the gels according to the invention may also comprise cationic surfactants and/or amphoteric surfactants.

Suitable amphoteric surfactants include for example betaines of the general formula (RIII)(RIV)(RV)N⁺CH₂COO⁻, wherein RIII denotes an alkyl group having 8 to 25, preferably 10 to 21, carbon atoms, optionally interrupted by heteroatoms or heteroatomic groups, and wherein RIV and RV denote the same or different alkyl groups having 1 to 3 carbon atoms. Such substances corresponding to the general formula include for example, C10 to C18 alkyl dimethyl carboxymethyl betaine and C11 to C17 alkylamidopropyl dimethylcarboxymethyl betaine.

Suitable cationic surfactants include, inter alia, the quaternary ammonium compounds of general formula (RVI)(RVII)(RVIII)(RIX)N⁺X⁻, in which RVI to RIX denote four identical or different types, in particular two long and two short chain alkyl groups, preferably having 1 to 40 carbon atoms, and wherein X⁻ denotes an anion, especially a halide ion. Such substances corresponding to the general formula include for example didecyl-dimethylammonium chloride, alkyl-benzyl-didecylammonium chloride, and their mixtures.

In preferred embodiments of the present invention the surfactants are respectively selected from nonionic and anionic surfactants or combinations thereof. In more preferred embodiments the surfactants are respectively selected from nonionic surfactants, most preferably fatty alcohol ethoxylates and alkyl polyglycosides and combinations thereof.

In preferred embodiments, the surfactants are respectively present in 1 to 60 wt.-%, more preferably 5 to 50 wt.-%, most preferably 20 to 40 wt.-%, based on the total weight of the respective gel.

The gels according to the present invention can optionally further comprise at least one perfume typically employed in the art. In preferred embodiments, only one gel comprises at least one perfume, in more preferred embodiment two gels comprise at least one perfume.

The at least one perfume are preferably incorporated in an amount of 0.0001 to 8 wt %, particularly in an amount of 0.005 to 5 wt %, and particularly preferably from 0.1 to 2.5 wt %, based on the total weight of the respective gel.

Perfumes are added to the compositions of the invention in order to improve the esthetic appeal of the products which are formed and to provide the consumer with not only the performance of the product but also a sensorial “typical and unmistakable” product. As perfume including perfume oils and/or fragrances it is possible to use individual odorant compounds, examples being the synthetic products of the ester, ether, aldehyde, ketone, alcohol, and hydrocarbon types. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate, and benzyl salicylate. The ethers include, for example, benzyl ethyl ether; the aldehydes include, for example, the linear alkanals having 8-18 carbon atoms, citral, citronellal, citronellyloxy-acetaldehyde, cyclamen aldehyde, hydroxycitronellal, lilial and bourgeonal; the ketones include, for example, the ionones, [alpha]-isomethylionone and methyl cedryl ketone; the alcohols include anethole, citronellol, eugenol, geraniol, linalool, phenylethyl alcohol, and terpineol; the hydrocarbons include primarily the terpenes such as limonene and pinene. Preference, however, is given to the use of mixtures of different odorants, which together produce an appealing fragrance note. Such perfume oils may also contain natural odorant mixtures, as are obtainable from plant sources, examples being pine oil, citrus oil, jasmine oil, patchouli oil, rose oil or ylang-ylang oil. Likewise, suitable are muscatel, clary sage oil, camomile oil, clove oil, balm oil, mint oil, cinnamon leaf oil, lime blossom oil, juniperberry oil, vetiver oil, olibanum oil, galbanum oil and labdanum oil, and also orange blossom oil, neroliol, orange peel oil, and sandalwood oil.

The gels according to the present invention can optionally further comprise at least one additive typically employed in the art.

The additives according to the present invention are preferably independently selected from, fillers, builders, thickeners, metal soaps, acids, bases, salts, thickeners, antimicrobials, preservatives, sequestrants, colorants, scents, perfume boosters, fillers, bleaching agents, corrosion inhibitors, flush regulators, enzymes, microorganisms, active substances for biofilm removal, lime-scale inhibitors, soil-adhesion inhibitors, and mixtures thereof. In total, not more than 60 wt % of additives should be included in the respective gel, preferably from 0.01 to 60 wt %, and in particular, 0.2 to 15 wt %, based on the total weight of the respective gel.

Exemplary thickeners which can be employed are inorganic thickeners like (polysilicic acids, clay minerals like montmorillonite, zeolite, silica).

Acids

The gels according to the invention may comprise one or more acids and/or their salts to increase the cleaning power against lime scale and urine scale. Organic acids, such as formic acid, acetic acid, citric acid, glycolic acid, lactic acid, succinic acid, adipic acid, malic acid, tartaric acid and gluconic acid as well as their mixtures are particularly suitable as the acids for the present invention. In addition, the mineral acids hydrochloric acid, sulphuric acid, phosphoric acid and nitric acid or even amido sulfonic acid or their mixtures can also be employed. The acids and/or their salts are preferably selected from the group consisting of citric acid, and lactic acid, any of their salts, and mixtures thereof. They are preferably employed in amounts of 0.01 to 10 wt %, and particularly preferably from 0.2 to 5 wt % based on the total weight of the respective gel.

The gels may additionally comprise inorganic salts. Such salts include alkali metal or alkaline earth metal salts, especially the carbonates, sulfates, halides, phosphates, and mixtures thereof. Sodium sulfate and/or sodium carbonate are preferably employed.

Bases

Additionally, various alkalis may be included in the gels according to the present invention. Those alkaline materials selected from the group of alkali metal and alkaline earth metal hydroxides and carbonates, especially sodium carbonate or sodium hydroxide, are preferably employed in the present inventive compositions as bases. In addition, however, ammonia and/or alkanolamines with up to 9 carbon atoms in the molecule can be used, preferably the ethanolamines, and especially monoethanolamine.

Antimicrobial Agents

Disinfection and sanitation represent a particular aspect of cleaning. Accordingly, in an additional embodiment of the invention, the gels according to the invention can comprises one or more antimicrobial agents, preferably in an amount of 0.01 to 3 wt %, advantageously 0.02 to 1 wt %, especially 0.05 to 0.5 wt %, particularly preferably 0.1 to 0.3 wt %, and most preferably 0.2 wt %, based on the total weight of the respective gel.

In the context of the inventive teaching, the terms disinfection, sanitation, antimicrobial action and antimicrobial agent have the usual technical meaning. Whereas disinfection in the strictest sense of medical practice means the killing of—theoretically all—infectious germs, in sanitation it is understood to mean the greatest possible elimination of all—even the saprophytic germs that are normally not harmful to humans. Here the degree of disinfection or sanitation depends on the antimicrobial action of the composition used which decreases with decreasing content of antimicrobial agent or increasing dilution of the composition used.

Inventively suitable exemplary antimicrobial agents are preferably selected from the group consisting of alcohols, amines, aldehydes, antimicrobial acids and salts thereof, carboxylic acid esters, acid amides, phenols, phenol derivatives, diphenyls, diphenylalkanes, urea derivatives, oxygen and nitrogen acetals and formals, benzamidines, isothiazolines, phthalimide derivatives, pyridine derivatives, antimicrobial surface-active compounds, guanidines, antimicrobial amphoteric compounds, quinolines, 1,2-dibromo-2,4-dicyanobutane, iodo-2-propinyl butyl carbamate, iodine, iodophores, compounds that split off active chlorine, peroxides, and mixtures thereof. Preferred antimicrobial agents are preferably selected from the group consisting of ethanol, n-propanol, i-propanol, 1,3-butanediol, phenoxyethanol, 1,2-propylene glycol, glycerin, undecylenic acid, citric acid, lactic acid, benzoic acid, salicylic acid, thymol, 2-benzyl-4-chlorophenol, 2,2′-methylene-bis-(6-bromo-4-chlorophenol), 2,4,4′-trichloro-2′-hydroxydiphenyl ether, N-(4-chlorphenyl)-N-(3,4-dichlorophenyl) urea, N,N′-(1,10-decanediyldi-1-pyridinyl-4-ylidene)bis-(1-octanamine)dihydrochloride, N,N′-bis-(4-chlorophenyl)-3,12-diimino-2,4,11,13-tetraazatetradecanediimidamide, antimicrobial quaternary surface active compounds, guanidine and sodium dichloroisocyanurate (DCI, 1,3-dichloro-5H-1,3,5-triazine-2,4,6-trione sodium salt), and mixtures thereof. Preferred antimicrobially active surface active quaternary compounds comprise an ammonium, sulfonium, phosphonium, iodonium or arsonium group. Furthermore, antimicrobially active ethereal oils can also be employed that simultaneously provide a perfuming benefit. Particularly preferred antimicrobial agents are selected from the group consisting of salicylic acid, quaternary surfactants, especially benzalkonium chloride, peroxy compounds, especially hydrogen peroxide, alkali metal hypochlorite, sodium dichloroisocyanurate, and mixtures thereof. In case a cationic surfactant as defined above should be present in the gels of the present invention, the optionally further contained antimicrobial agent is different from this cationic surfactant.

Preservatives

Preservatives may also be incorporated in the gels according to the invention. Essentially, the substances cited above as antimicrobial agents may also function as preservatives.

Chelating Agents

The INCI term chelating agents, also known as sequestrants, are ingredients that are capable of complexing and inactivating metal ions so as to prevent their detrimental action on the stability or on the appearance of the agent, e.g. turbidity. It is important to complex the calcium and magnesium ions in hard water as they are incompatible with numerous ingredients. The complexation of the ions of heavy metals such as iron or copper also retards the oxidative decomposition of the finished composition. In addition, the chelating agents support the cleaning action.

The following exemplary chelating agents named according to INCI are suitable: aminotrimethylene phosphonic acid, beta-alanine diacetic acid, calcium disodium EDTA, citric acid, cyclodextrin, cyclohexanediamine tetraacetic acid, diammonium citrate, diammonium EDTA, diethylenetriamine pentamethylene phosphonic acid, dipotassium EDTA, disodium azacycloheptane diphosphonate, disodium EDTA, disodium pyrophosphate, EDTA, etidronic acid, galactaric acid, gluconic acid, glucuronic acid, HEDTA, hydroxypropyl cyclodextrin, methyl cyclodextrin, pentapotassium triphosphate, pentasodium aminotrimethylene phosphonate, pentasodium ethylenediamine tetramethylene phosphonate, pentasodium pentetate, pentasodium triphosphate, pentetic acid, phytic acid, potassium citrate, potassium EDTMP, potassium gluconate, potassium polyphosphate, potassium trisphosphonomethylamine oxide, ribonic acid, sodium chitosan methylene phosphonate, sodium citrate, sodium diethylenetriamine pentamethylene phosphonate, sodium dihydroxyethylglycinate, sodium EDTMP, sodium gluceptate, sodium gluconate, sodium glycereth-1 polyphosphate, sodium hexametaphosphate, sodium metaphosphate, sodium metasilicate, sodium phytate, sodium polydimethylglycinophenolsulfonate, sodium trimetaphosphate, TEA-EDTA, TEA-polyphosphate, tetrahydroxyethyl ethylenediamine, tetrahydroxypropyl ethylenediamine, tetrapotassium etidronate, tetrapotassium pyrophosphate, tetrasodium EDTA, tetrasodium etidronate, tetrasodium pyrophosphate, tripotassium EDTA, trisodium dicarboxymethyl alaninate, trisodium EDTA, trisodium HEDTA, trisodium NTA and trisodium phosphate.

Colorants

The toilet cleaner block according to the invention can comprise one or more colorants as additional ingredients. Both water-soluble as well as oil-soluble colorants can be used as the colorants. In the selection of suitable colorants one has to take care of the compatibility with other ingredients present, for example bleaching agents, and one has to ensure added colorant does not substantively stain the toilet ceramics, even after long periods of action. The colorants are preferably incorporated in an amount of 0.0001 to 0.1 wt %, particularly in an amount of 0.0005 to 0.05 wt %, and particularly preferably from 0.001 to 0.01 wt %, based on the total weight of the respective gel.

Builders

Water-soluble and/or water-insoluble builders can optionally be employed in gels according to the invention. Here, water-soluble builders are preferred, as they generally have less of a tendency to leave behind insoluble residues on hard surfaces. Conventional builders which may be present in accordance with the invention include low molecular weight polycarboxylic acids and salts thereof, the homopolymeric and copolymeric polycarboxylic acids and salts thereof, citric acid and salts thereof, carbonates, phosphates and silicates. Water-insoluble builders include the zeolites, which can also be used, as well as mixtures of the above described builder substances.

Bleaching Agents

Bleaching agents may also be included into the gels of the present invention. Suitable bleaching agents include peroxides, peracids and/or perborates. Particularly preferably for use herein is hydrogen peroxide. In contrast, sodium hypochlorite is less suitable in acidic cleaning agents due to the release of poisonous chlorine gas vapor, but can be employed in cleaning agents adjusted to alkaline pH. In certain circumstances a bleach activator can also be used in addition to the bleaching agent.

Corrosion Inhibitors

Suitable corrosion inhibitors include for example the following substances named according to INCI: Cyclohexylamine, Diammonium Phosphate, Dilithium Oxalate, Dimethylamino Methylpropanol, Dipotassium Oxalate, Dipotassium Phosphate, Disodium Phosphate, Disodium Pyrophosphate, Disodium Tetrapropenyl Succinate, Hexoxyethyl Diethylammonium, Phosphate, Nitromethane, Potassium Silicate, Sodium Aluminate, Sodium Hexametaphosphate, Sodium Metasilicate, Sodium Molybdate, Sodium Nitrite, Sodium Oxalate, Sodium Silicate, Stearamidopropyl Dimethicone, Tetrapotassium Pyrophosphate, Tetrasodium Pyrophosphate, Triisopropanolamine.

Flush Regulators

The substances designated as flush regulators act primarily to control the consumption of the agent during use in such a way that the intended lifetime is optimized. Solid long-chain fatty acids, such as stearic acid, are preferred regulators. Also, fatty acid ethanolamides, such as coco fatty acid monoethanolamide, or solid polyethylene glycols, such as those having number average molecular weights between 10,000 and 50,000 g/mol, determined via GPC employing polystyrene standards, are suitable flush regulators. If present in the gels, the flush regulator is different from the surfactant.

Enzymes

The gels can also comprise enzymes, for example proteases, phosphatases, lipases, amylases, hydrolases and/or cellulases. The enzymes can be added to the respective gel in each form established according to the prior art. These include solutions of the enzyme, advantageously as concentrated as possible, anhydrous and/or with added stabilizers. Alternatively, the enzymes can be encapsulated, for example by spray drying or extrusion of the enzyme solution together with a preferably natural polymer or in the form of capsules, for example those in which the enzyme is embedded in a solidified gel, or in those of the core-shell type, in which an enzyme-containing core is coated with a water-, air- and/or chemical-impervious protective layer. Further active principles, for example stabilizers, emulsifiers, pigments, bleaches or colorants can be applied in additional layers. Such capsules are made using known methods, for example by vibratory granulation or roll compaction or by fluidized bed processes. Advantageously, these types of granulates, for example with a coated polymeric film former, are dust-free and as a result of the coating are storage stable.

In addition, enzyme stabilizers can be present in the enzyme-containing agent, in order to protect an enzyme comprised in an agent according to the invention against damage such as for example inactivation, denaturing or decomposition for example by physical effects, oxidation or proteolytic cleavage. Each depending on the enzyme used, the following are suitable as enzyme stabilizers: benzamidine hydrochloride, borax, boric acid, boronic acids or their salts or esters, primarily derivatives containing aromatic groups, for example substituted phenylboronic acids or their salts or esters; peptide aldehydes (olgopeptides with reduced C-terminus), amino alcohols such as mono-, di-, triethanolamine and mono-, di-, tripropanolamine and their mixtures, aliphatic carboxylic acids up to C12, such as succinic acid, other dicarboxylic acids or salts of the cited acids, end blocked fatty acid amide alkoxylates; aliphatic lower alcohols and primarily polyols, for example glycerin, ethylene glycol, propylene glycol or sorbitol, as well as reducing agents and antioxidants such as sodium sulfite and reducing sugars. Further suitable stabilizers are known from the prior art. The use of combinations of stabilizers is preferred, for example the combination of polyols, boric acid and/or borax, the combination of boric acid or borate, reducing salts and succinic acid or other dicarboxylic acids or the combination of boric acid or borate with polyols or polyamino compounds and with reducing salts.

In preferred embodiments of the present invention, the gels have a viscosity of at least 15,000 mPas, more preferably at least 80, 000 mPas, even more preferably at least 100,000 mPas, most preferably at least 120,000 mPas. In further preferred embodiments, the upper limit is at most 25,000,000 mPas, preferably at most 10,000,000 mPas, even more preferably at most 1,000,000 mPas, most preferably at most 300,000 mPas.

In preferred embodiments adjacent gels, i.e., the self-adhesive gel layer, differ in their viscosity from 0.1 to 100,000, preferably 1 to 50,000, more preferably from 5 to 10,000 mPas, most preferably 5 to 1,000 mPas.

In most preferred embodiments, the viscosity (measured with a Rheometer: AR G2 at 20° C. (2 cm Peletier Plate and a gap distance of 300 μm)) is between 50,000 mPas to 1,200,000 mPas, preferably 80,000 mPas to 1,100,000 mPas.

The viscosity of the gels according to the present invention is preferably measured with a rheometer Texture Analyzer Discovery HR-2, cone-plate type, cone diameter 40 mm, angel 1°; with a shear rate of 10 1/sec. at 20° C. or a Rheometer: AR G2 at 20° C. (2 cm Peletier Plate and a gap distance of 300 μm).

In preferred embodiments, the gels according to the present invention have a storage modulus G′ (oscillatory measurements, measured at 20° C., 1 Hz, 0.1% strain deformation preferably with a Rheometer: Ki nexus Ultra+, 2 cm Peletier Plate gap distance of 300 μm) of 0.9E+02 to 1.8E+05 Pa, preferably 1.0E+02 to 1.6E+05 Pa.

To determine whether the multi-layer gel has a continuous, essentially even surface, remote from the flat surface of the substrate upon which it has been applied, following method can be used. The multi-layer self-adhesive gel is applied to an even stainless steel plate or ceramic tile. Then the gel is visually inspected if no gap is observable between the different gels. In case no gap is present, the gel is considered continuous. Subsequently, the gel is frozen with liquid nitrogen, the width and the length of the borders is measured and a rigid even plastic sheet (having a thickness of about 1 to 3 mm) which has 140% of the length and the width of the respective edges is placed upon the gel so that 20% (+/−0.5%) protrude on each side. The sample size should at most be 8 cm in width and 10 cm in length. For example, when a gel having a width of 2 cm and a length of 4 cm is measure, a plastic plate having 2.8 cm and 5.6 cm is employed. The plastic plate will protrude in the width on every side for 0.4 cm and in the length for 0.8 cm. Then the perpendicular distance between the protruding lower surface of the plastic plate and the stainless steel plate or ceramic tile is measured, e.g., with a sliding caliper, in the middle and on the outermost position of each of the four sides. The two measured values for the width and the length are respectively compared and in case the deviation of the length and width is within 20%, preferably 15, more preferably 10%, then the surface is considered to be essentially even.

In preferred embodiments, an amount of 4 to 8 g of the multi-layer self-adhesive gel is applied. In further preferred embodiments, the applicator according to the present invention can comprise 1 to 5 portions of the multi-layer self-adhesive gel having 4 to 8 g each. The gels after application on the toilet are preferably completely dissolved after 100 to 200 flushes.

The gels according to the present invention are prepared as commonly known in the art. For examples as disclosed in EP 1325103 A, EP 1086199 and WO 2014033259 A.

Exemplary combinations of (A) and (B) and optionally (C) are shown in the following table.

| Use | Gel (A) | Gel (B) | optional gel (C) |
|---|---|---|---|
| lavatory | antimicrobial gel | scenting gel | gel with high amount |
| cleaning | | | of surfactant |
| lavatory | bleaching agent | gel with high | scenting gel |
| cleaning | comprising gel | amount | |
| | | of surfactant | |
| lavatory | basic gel | scenting gel | enzyme comprising |
| cleaning | | | gel |
| lavatory | builder comprising | antimicrobial gel | scenting gel |
| cleaning | gel | | |
| sink | enzym comprising | acidic gel | scenting gel |
| cleaning | gel | | |

Applicator

Additionally, an applicator for multi-layer self-adhesive gels, in particular a toilet cleaning product is provided herein.

The applicator comprises one receiving chamber containing the multi-layer self-adhesive gel according to the present invention and having

a first opening, wherein the first opening is provided in order to release the gel,
and a second opening, wherein the second opening is provided in order to accommodate a piston, which can be moved in the receiving chamber and by means of which the gel can be pushed through the first opening, and wherein
the multi-layer self-adhesive gel is arranged in the receiving chamber so that parts of all self-adhesive layers, preferably equal amounts of each of the adhesive layers, contained in the receiving chamber are able to simultaneously leave the receiving chamber through the first opening.

In preferred embodiments, the first opening of the applicator has at least one straight edge, in more preferred embodiments the first opening has a square shape.

In preferred embodiments of the applicator, around the first opening of the receiving space, there are arranged at least two, preferably at least three spacer elements which are configured such that, when the applicator is pressed onto, in particular a ceramic toilet surface to which the multi-layer self-adhesive gel is to be applied, a gap A is formed between the first opening and the surface and the multi-layer self-adhesive gel may flow freely around the spacer elements on discharge.

The number and arrangement of the spacer elements may, by allowing the preparation(s) to flow in corresponding manner around the spacer elements, result in targeted shaping of the multi-layer self-adhesive gel to be applied. The small contact surface in the configuration according to the invention between applicator and application surface minimize unavoidable soiling (bacteria, microorganisms) of the applicator or of the multi-layer self-adhesive gel during the application process.

Creation of a gap A between the first opening of a receiving space and the surface for application and the arrangement of spacers around the first opening ensures that the area of product contact with the surface is greater than the product outlet area from the first opening. The resultant different levels of adhesive force when withdrawing the applicator from the relevant surface ensure the multi-layer self-adhesive gel is torn off easily and cleanly from the applicator.

Because the spacer elements define the flow of a gel-form preparation only in places on application thereof, owing to the gel-form preparation being able to flow around the spacer elements, dispensing appropriate to the circumstances is also made possible, such that a greater or lesser quantity of gel-form preparation may be dispensed by the user for example depending on the desired cleaning performance of the multi-layer self-adhesive gel within a toilet bowl.

Use of the spacer elements according to the invention around which preparation may flow thus also makes it possible in particular to apply a dispensing amount differing from a single dispensing amount, in particular a double dispensing amount, to a toilet bowl. It is thus in particular also feasible for the applicator to be configured in such a way that flow around the spacer elements only occurs from a double dispensing amount, such that the user can identify from the geometry of the applied gel body whether a single, double or indeed multiple dispensing amount has been released. In addition, in such a configuration of the applicator it is likewise possible for a user to detect multiple dispensing during the application process when the applied gel begins to flow around the spacer elements and thus to protrude from the projection of the applicator contour.

To provide good demoldability from an injection mold and a minimal surface wetable by preparation during the application process, it is advantageous for the spacer elements to be of rod-shaped, in particular cylindrical construction. The cross-section of the rod-shaped spacer elements may for example however also be square, rectangular, oval, triangular, cross-shaped or star-shaped.

To ensure good product tear-off and satisfactory adhesion of the preparation to the surface, in an embodiment, the spacer elements are configured such that, when the applicator is pressed onto a surface to which the multi-layer self-adhesive gels are to be applied, a gap is formed between the first openings of the receiving spaces and the relevant surface of about 0.5 mm to about 30 mm, preferably about 2 mm to about 10 mm.

In a preferred embodiment of the invention, the spacer elements are arranged on an adapter which may be fixed form-fittingly and/or frictionally detachably or nondetachably to the applicator. This makes it possible to offer differently positioned spacer elements, which in each case bring about different shaping of the multi-layer self-adhesive gels on the surface to which they are to be applied, such that a user may for example select a preferred shape.

The applicator according to the invention is suitable for applying multi-layer self-adhesive gels to surfaces. In particular, the applicator is suitable for applying a toilet cleaning preparation to a ceramic toilet surface. In addition, the applicator according to the invention may be used to apply multi-layer self-adhesive gel preparations such as for example textile washing agents and/or washing auxiliaries to a surface, such as for example the inside of a washing machine door or in a dispensing compartment of a dispensing drawer of a washing machine. It is additionally feasible for a dishwashing preparation to be applied by means of the applicator according to the invention for example to the inside of a dishwashing machine door, into the dispensing chamber of a dishwashing machine or the like.

The applicator according to the present invention can be filled with the following methods:

A first method for filling of the applicator according to the present invention, wherein

a first gel is molten and filled in a first filling step into the receiving chamber through the first opening, subsequently the gel is allowed to cool or actively cooled, with the applicator being in a horizontal position, until it becomes solid and forms the first self-adhesive gel layer (A); then
a second gel is molten and filled in a second filling step into the receiving chamber via the first opening,
subsequently the gel is allowed to cool or actively cooled until it becomes solid, forming the second self-adhesive gel layer (B);
optionally then a third gel is molten and filled in a third filling step into the receiving chamber via the first opening, with the proviso that the applicator in the cooling step of the second filling step is in a horizontal position;
with the proviso that the piston is present in the receiving chamber from the beginning of the filling steps.

A second method for filling of the applicator according the present invention, wherein

a molten first gel, forming the first self-adhesive gel layer (A), and a molten second gel, forming the second self-adhesive gel layer (B) and optionally a molten third gel, forming the third self-adhesive gel layer (C), are simultaneously filled into the receiving chamber via nozzles of a gel providing apparatus through the second opening; wherein at least one separative element is present between the nozzles for avoiding mixing of the gels being filled into the receiving chamber, and wherein the at least one separative element is pulled out of the receiving chamber, together with the nozzles, through the second opening until the receiving chamber is filled up to the means for pressure compensation.

A third method for filling the applicator according to claim 10 or 11, comprising the steps:

providing the receiving chamber in a horizontal position;
pumping a first gel, forming the first self-adhesive gel layer (A) into the receiving chamber with a temperature of the gel below at least 60° C. of its gel point; and
simultaneously filling a molten second gel, forming the second self-adhesive gel layer (B), into the receiving chamber, wherein
the second gel congeals at the interface with the first gel.

In preferred embodiments, according to the third method a positive displacement pump is used, like twin-screw extruder or progressive cavity pumps. In further preferred embodiments, the positive displacement pump should be capable of maintaining a desired temperature, e.g., through storage container and heating elements.

### Examples

In the following formulations, the amounts refer to wt.-%.

Formulations (F) 1 to 4

| | Example 1 | | Example 2 | |
|---|---|---|---|---|
| | F1 | F2 | F3 | F4 |
| Components | Scenting | Cleaning | Scenting | Cleaning |
| Polymer (ester of poly- | 40.00 | 40.00 | — | — |
| isobutene succinic acid) | | | | |
| Hostapur SAS 60 | 30.10 | 30.10 | 40.50 | 40.50 |
| Laponit TM (filler) | — | — | 25.00 | 25.00 |
| Perfume | 4.90 | 4.90 | 4.90 | 4.90 |
| bittern (Bitrex) | 0.0010 | 0.0010 | 0.0010 | 0.0010 |
| Trisodium citrate | — | 0.10 | — | 0.10 |
| Colorant yellow | 0.0150 | — | 0.0150 | — |
| Colorant blue | — | 0.0130 | — | 0.0130 |
| Demineralised water | ad 100 | ad 100 | ad 100 | ad 100 |

Hostapur SAS 60 is a secondary C13-17-alkane sulfonate from Clariant.

Formulations 5 and 6

Example 3

| Components | F5 color | F6 color |
|---|---|---|
| Ethoxylated C16-18 Fatty alcohol | 25.00 | 25.00 |
| (25 EO) | | |
| Glycerin 99.5% | 9.90 | 9.90 |
| polyoxyethylene cetylstearyl ether | 4.80 | 4.80 |
| Perfume | 4.90 | 4.90 |
| C12-14 Sodium lauryl ether sulfate | 6.86 | 6.86 |
| (2EO) | | |
| Polyoxyethylene Hydrogenated | 2.00 | 2.00 |
| Castor Oil | | |
| Colorant yellow | 0.008 | — |
| Colorant blue | — | 0.004 |
| Demineralised water | ad 100 | ad 100 |

Formulations 1 to 6 have been respectively filled into an applicator according to the first and second method of the present invention. Subsequently, the multi-layer self-adhesive gels according to the present invention have been applied into a toilet. The resulting gels showed an even dissolution and were completely dissolved after about 120 flushes.

Further preferred embodiments are set out in the dependent claims.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A multi-layer self-adhesive gel for cleaning, disinfecting, deodorizing, and/or scenting, comprising:
i) a first self-adhesive gel layer (A) comprising
a first solvent (a1),
a first adhesion promoter (b1), said first adhesion promoter (b1) being different from said first solvent (a1); and
a first surfactant (c1), said first surfactant (c1) being different from said first adhesion promoter (b1) and said first solvent (a1);
ii) a second self-adhesive gel layer (B) comprising
a second solvent (a2), and
a second adhesion promoter (b2), said second adhesion promoter (b2) being different from said second solvent (a2);
wherein said second self-adhesive gel layer (B) is different from said first self-adhesive gel layer (A); and
wherein when said multi-layer self-adhesive gel is applied onto a flat surface of a substrate, said second self-adhesive gel layer (B) and said first self-adhesive gel layer (A) together form a continuous, essentially even surface, remote from the surface of the substrate.

2. The multi-layer self-adhesive gel according to claim 1, wherein said second self-adhesive gel layer (B) further comprises a second surfactant (c2); wherein said second surfactant (c2) is different from said first adhesion promoter (b2) and said first solvent (a2).

3. The multi-layer self-adhesive gel according to claim 1, further comprising
iii) a third self-adhesive gel layer (C) comprising
a third solvent (a3), and
a third adhesion promoter (b3), said third adhesion promoter (b3) being different from said third solvent (a3);
wherein said third self-adhesive gel layer (C) is different from the first self-adhesive gel layer (A) and the second self-adhesive gel layer (B); and
wherein when said multi-layer self-adhesive gel is applied onto a flat surface of a substrate, the first, second, and third adhesive gel layers (A), (B) and (C) together form a continuous, essentially even surface, remote from the surface of the substrate.

4. The multi-layer self-adhesive gel according to claim 2, further comprising:
iii) a third self-adhesive gel layer (C) comprising
a third solvent (a3), and
a third adhesion promoter (b3), said third adhesion promoter (b3) being different from said third solvent (a3);
wherein said third self-adhesive gel layer (C) is different from the first self-adhesive gel layer (A) and the second self-adhesive gel layer (B); and
wherein when said multi-layer self-adhesive gel is applied onto a flat surface of a substrate, the first, second, and third adhesive gel layers (A), (B) and (C) together form a continuous, essentially even surface, remote from the surface of the substrate.

5. The multi-layer self-adhesive gel according to claim 4, wherein said third self-adhesive gel layer (C) further comprises a third surfactant (c3); wherein said third surfactant (c3) is different from said first adhesion promoter (b3) and said first solvent (a3).

6. The multi-layer self-adhesive gel according to claim 3, wherein each of said first, second, and third adhesion promoters is independently selected from fatty alcohol ethoxylates, cellulose, polysaccharides or derivatives thereof, oligosaccharides or derivatives thereof, monosaccharides or derivatives thereof, alginates, diurethanes, pectines, oleyl amines, alkyl dimethyl amine oxides, stearates, sodium dodecylbenzene sulfonates, gelatines, starches, modified starches, agar, acacia gum, carob bean flour, oligomers and polymers, polyvinyl alcohols and polyvinyl pyrrolidones, or combinations thereof.

7. The multi-layer self-adhesive gel according to claim 3, wherein each of said first, second, and third self-adhesive gel layers has a viscosity of at least 15,000 mPas.

8. The multi-layer self-adhesive gel according to claim 3, wherein adjacent self-adhesive gels differ in their viscosity from 0.1 to 100,000 mPas.

9. The multi-layer self-adhesive gel according to claim 3, wherein each of said first, second, and third adhesion promoters is present in 1 to 60 wt. % based on the total weight of the respective gel layer.

10. The multi-layer self-adhesive gel according to claim 5, wherein each of said first, second, and third surfactants is independently selected from anionic-surfactants, nonionic-surfactants, amphoteric surfactants, or combinations thereof.

11. The multi-layer self-adhesive gel according to claim 5, wherein each of the first, second, and third surfactants is present in 1 to 60 wt. % based on the total weight of the respective gel layer.

12. A method for cleaning, disinfecting, deodorizing, and/or scenting of toilets, sinks, wash-bowls, bathtubs, showers and for delivery of shower gel or shampoo in the shower, bathtub or wash-bowl comprising a step of:
applying the multi-layer self-adhesive gel according to claim 1 onto a flat surface of a substrate to be cleaned, disinfected, deodorated, and/or scented.

13. An applicator comprising:
a receiving chamber for receiving the multi-layer self-adhesive gel according to claim 1, a first opening, and a second opening,
wherein the first opening is provided in order to release the gel,
wherein the second opening is provided in order to accommodate a piston, which can be moved in the receiving chamber and by means of which the gel can be pushed through the first opening, and
wherein the multi-layer self-adhesive gel is arranged in the receiving chamber so that parts of all self-adhesive layers contained in the receiving chamber are able to simultaneously leave the receiving chamber through the first opening.

14. The applicator according to claim 13, wherein the receiving chamber has a means for pressure compensation at the second opening.

15. The applicator according to claim 14, wherein the means for pressure compensation is a breather hole.

16. The applicator according to claim 13, wherein the applicator is a toilet cleaning product.

17. A method for filling the applicator according to claim 13, wherein
a first gel is molten and filled in a first filling step into the receiving chamber through the first opening, subsequently the gel is allowed to cool or actively cooled, with the applicator being in a horizontal position, until it becomes solid and forms the first self-adhesive gel layer (A); then
a second gel is molten and filled in a second filling step into the receiving chamber via the first opening,
subsequently the gel is allowed to cool or actively cooled until it becomes solid, forming the second self-adhesive gel layer (B);
optionally then a third gel is molten and filled in a third filling step into the receiving chamber via the first opening, with the proviso that the applicator in the cooling step of the second filling step is in a horizontal position;
with the proviso that the piston is present in the receiving chamber from the beginning of the filling steps.

18. A method for filling the applicator according to claim 13,
wherein a molten first gel, forming the first self-adhesive gel layer (A), and a molten second gel, forming the second self-adhesive gel layer (B) and optionally a molten third gel, forming the third self-adhesive gel layer (C), are simultaneously filled into the receiving chamber via nozzles of a gel providing apparatus through the second opening; wherein at least one separative element is present between the nozzles for avoiding mixing of the gels being filled into the receiving chamber, and wherein the at least one separative element is pulled out of the receiving chamber, together with the nozzles, through the second opening until the receiving chamber is filled up to the means for pressure compensation.

19. A method for filling the applicator according to claim 13, comprising the steps of:
providing the receiving chamber in a horizontal position;
pumping a first gel, forming the first self-adhesive gel layer (A) into the receiving chamber with a temperature of the gel below at least 60° C. of its gel point; and
simultaneously filling a molten second gel, forming the second self-adhesive gel layer (B), into the receiving chamber,
wherein the second gel congeals at the interface with the first gel.
